(19) United States
(12) Patent Application Publication
(10) Pub. No.: US 2007/0292964 A1
(43) Pub. Date: Dec. 20, 2007

(54) Measuring Equipment and Measuring Method

(75) Inventors: Fumihisa Kitawaki, Ehime-ken (JP); Hirotaka Tanaka, Ehime-ken (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/574,315

(22) PCT Filed: Sep. 8, 2005
(86) PCT No.: PCT/JP05/16525

§ 371 Date: Feb. 27, 2007

(30) Foreign Application Priority Data
Sep. 10, 2004 (JP) 2004-263615

(51) Int. Cl. G01N 21/17

(52) U.S. Cl. 436/165; 422/55

(57) ABSTRACT

Herein disclosed is a measuring equipment, comprising: a light source (13); a light receiving unit (14) disposed in spaced relationship with the light source (13); a device (11) disposed between the light source (13) and the light receiving unit (14); the device (11) having a reaction part (12) for accommodating therein a solid phase support (121), a test substance in a specimen, and a test reagent operative to react with any one of the solid phase support (121) and the test substance, the solid phase support (121) having a surface having a specific binding substance fixed thereon, the specific binding substance being specifically reactive with the test substance, in which, the specific binding substance is adapted to have a plurality of concavities and convexities (123) formed on the solid phase support with the test reagent and the test substance introduced into the reaction part (12) and reacted with each other, the light source (13) is operative to produce a light to transmit through the solid phase support (121) and scan the device (11), the light transmitted through the solid phase support (121) having a signal indicative of the concavities and convexities (123) on the solid phase support (121), the signal of the light indicative of the concavities and convexities (123) transmitted through the solid phase support (121) being detected by the light receiving unit (14).

### TECHNICAL FIELD OF THE INVENTION

The present invention relates to a measuring equipment mainly used in a field of clinical assay.

### DESCRIPTION OF THE RELATED ART

In recent years, there have been developed measuring equipments for various types of materials resulting from the development of technologies used for assay, analysis, and inspection. Especially in the field of clinical assay, development of measuring methods on the basis of a specific reaction such as biochemical reaction, enzyme reaction, or immune reaction makes it possible to measure materials contained in a body fluid, the materials reflecting a clinical condition.

Among other things, a Point of Care Testing, hereinafter referred to as “POCT”, receives attention in the field of clinical assay. The principal purpose of the POCT is to conduct an easy and quick measurement that reduces time needed to obtain a result of the testing after a specimen is extracted from a body. Accordingly, it is necessary for the POCT to be conducted with simple measurement principal, and to be conducted by a measuring equipment which is small in size and excellent in portability and operability.

With the progress of the recent technology, small measuring equipments which allow easy testing, typified by a sensor for blood glucose, have been developed. The POCT is effective in that the POCT makes it possible to conduct an accurate and quick diagnosis resulting from the quick acquisition of the measurement result, along with reduction in cost for examination, reduction in burden imposed on the patient by reducing the amount of specimen, such as blood, extracted from the body, and reduction in the amount of infectious waste. The clinical examination is rapidly shifting to the POCT, which results in the development of a measurement device operable to conduct the POCT to meet the needs for the POCT.

The measurement device for the POCT is applied not only to an enzyme sensor based on a reaction on an enzyme electrode typified by the above-mentioned blood glucose sensor, but also to a qualitative immune sensor based on an immunizing antigen-antibody reaction typified by a diagnostic product for pregnancy. In addition, Micro Total Analysis System (hereinafter simply referred to as “μ-TAS”), typified by a capillary electrophoresis, has been developed. The development of these applications attributes to the establishment of the simple measuring method, and the development of the technology to make a solid phased biological sample, the technology to realize a device equipped with a sensor, the technology to realize a system equipped with a sensor, the technology of fine processing, and the technology of micro-fluidic control technology.

However, smaller the measurement device of the μ-TAS is, smaller the amount of reagent and the size of the detective part are, which results in the fact that the detection sensitivity of the detective part becomes lower than that of conventional spectrometers such as an absorption spectrometer and a fluorescence spectrometer.

The device based on the electrophoresis, typifying the μ-TAS, comprises a detective part having a microchip. In the case that the microchip is applied to a microchip electrophoresis, the microchip has the light path length of 10 μm under the condition that the light is injected along the direction perpendicular to the surface of the microchip. The light path length of this device is one fifth of the light path length of a conventional widely-used capillary electrophoresis. The light path length of the conventional widely-used capillary electrophoresis is as short as 50 μm. According to the above-mentioned facts, it is one of the main objects to increase the detection sensitivity of the detective part.

For compensating the reduction of detection sensitivity while reducing the size of the measurement device, some approaches have been taken so far, such as for example extending the light path length by making the injected light reflected with reflecting plates as disclosed in Japanese Patent Laying-Open Publications No. H09-304338 and No. H09-218149 (hereinafter simply referred to as Patent Publications 1 and 2), condensing the object to be measured in a pretreatment process as disclosed in Japanese Patent Laying-Open Publication No. H09-210960 (hereinafter simply referred to as Patent Publication 3), and detecting the light on the basis of the chemiluminescent detection as disclosed in Japanese Patent Laying-Open Publication No. 2000-338085 (hereinafter simply referred to as Patent Publication 4).

The measurement device with the extended light path length disclosed in Patent Publications 1 and 2, however, encounters such a problem that it is difficult to obtain the result of the measurement with reproducibility. This results from the fact that the detection sensitivity varies in response to the thickness of the detection part regardless of the light path length. There are additional variations which attribute to the low reproducibility in measurement, such as for example a variation in the angle of the reflecting plate and a variation in the distance between two reflecting plates. Moreover, the variation in the angle of injected light magnifies the variation in the result of the measurement.

The measurement device with the measured object to be condensed in the pretreatment process disclosed in Patent Publication 3, however, encounters such a problem that an additional operation to adjust the voltage applied to the detective part is required. Meanwhile, the measurement device, typifying the immunochromatographic assay, comprises a nitrocellulose membrane having immobilized antibody line mounted thereon, while specimen liquid is flowed through the immobilized antibody line so that the specimen liquid reacts with immobilized antibody line at all times to have the equivalent effect of condensing the object to be measured. However, the measurement device disclosed in Patent Publication 3 encounters such a problem that it is required to reduce the variation in the fluid velocity to increase the accuracy of the measurement. This measurement device encounters such another problem that the detection sensitivity is saturated in the case that the light to be detected has high intensity.

The measurement device for detecting the light on the basis of the chemiluminescent, bioluminescent, and enzyme luminescent detection disclosed in Patent Publication 4, however, encounters such a problem that although high detection sensitivity is expected as the detective part can detect each photon, the cost is relatively high due to the fact that the measurement device comprises a photomultiplier tube for detecting luminescence which is expensive. Moreover, the measurement device is not simple in operation due to the fact that additional steps for reacting process are required to detect the light resulting from the fact that specific reagent is required to have the object produce luminescence. The additional steps for reacting process as aforementioned could be operated by adjusting the voltage applied to the detective part with the control system, which are the same steps for microchip electrophoresis. However, the measurement device of this type encounters such another problem that the control system tends to be complicated in structure.

As a result, it is necessary to establish a measuring equipment for μ-TAS which can measure a test substance with high detection sensitivity, wide range of light intensity, and independent of the light path length while requiring no pretreatment process.

### SUMMARY OF THE INVENTION

It is, therefore, an object of the present invention to provide a measuring equipment and measuring method which can measure a test substance with high accuracy and simple construction.

According to one aspect of the present invention, there is provided a measuring equipment comprising: a light source; a light receiving unit disposed in spaced relationship with the light source; a device disposed between the light source and the light receiving unit; the device having a reaction part for accommodating therein a solid phase support, a test substance in a specimen, and a test reagent operative to react with any one of the solid phase support and the test substance, the solid phase support having a surface having a specific binding substance fixed thereon, the specific binding substance being specifically reactive with the test substance, in which, the specific binding substance is adapted to have a plurality of concavities and convexities formed on the solid phase support with the test reagent and the test substance introduced into the reaction part and reacted with each other, the light source is operative to produce a light to transmit through the solid phase support and scan the device, the light transmitted through the solid phase support having a signal indicative of the concavities and convexities on the solid phase support, the signal of the light indicative of the concavities and convexities transmitted through the solid phase support being detected by the light receiving unit.

Each of the concavities and convexities on the solid phase support may be formed with a shaped substance having a permeability to light.

The light receiving unit may be constituted by two divided light receiving portions, and the light receiving unit may be operative to measure an intensity of the light transmitted through the solid phase support, the intensity being varied in response to the shape of each of the concavities and convexities.

The concavities and convexities may be scanned with the light source by shifting the relative position of the light source with respect to the device with a predetermined space interval.

The device may be constituted by a rotary table operative to rotate around the central axis of the rotary table, and the concavities and convexities may be scanned under the condition that the rotary table is rotated.

The rotation velocity and the rotation time of the device may be determined in such a way that the device has a nonspecific binding substance removed from the device after the test reagent is introduced in the device.

The device may further include a reagent holder to have the reagent held therein in a dry condition, and a conduit to connect the reagent holder with the reaction part and having a passageway formed therein to allow the reagent in the reagent holder to pass to the reaction part.

The test reagent may be made of at least one shaped substance labeled with any one of an additional test substance and a substitute substance to ensure that the test substance is easily inspected by intercepting the light from the light source to the light receiving unit, the substitute substance having a structural domain similar to the structural domain of the additional test substance.

The test reagent may be made of a shaped substance labeled with an additional specific binding substance reactive with the test substance to ensure that the test substance is easily inspected by intercepting the light from the light source to the light receiving unit.

The test reagent labeled with any one of the additional test substance and the substitute substance may be adapted to form each of the concavities and convexities on the solid phase support, and the additional test substance and the substitute substance may be reacted with the specific binding substance competitively with the test substance in the specimen.

The additional specific binding substance may be specifically reactive with the test substance, and fixed with the specific binding substance through the test substance in the specimen to form each of the concavities and convexities on the solid phase support.

The measuring equipment may further comprise display means for displaying an image indicative of the signal, the signal specific to a shape of each of the concavities and convexities on the solid phase support.

According to one aspect of the present invention, there is provided a measuring method of measuring an amount of test substances in a specimen, comprising: a fixing step of fixing a specific binding substance on a solid phase support, the specific binding substance being specifically attached to the test substances, a forming step of forming concavities and convexities on the solid phase support by introducing a test reagent and the specimen on the solid phase support, the test reagent being reactive with any one of the test substance and the specific binding substance, a detecting step of detecting a light projected on the solid phase support, the light having a specific signal indicative of the concavities and convexities on the solid phase support, the light being detected in such a way that the amount of test substances is measured on the basis of the specific signal.

The measuring equipment according to the present invention is operative to measure the number of concavities and convexities formed on the solid phase support based on the detection of specific signals indicative of the concavities and convexities, which leads to the fact that the measuring equipment can conduct the optical measurement by measuring the change of the shape on the surface, while being independent of the light path length. This results in the fact that the measuring equipment can measure the test substance even if the size of the device is small. Additionally, it is unnecessary for the test substance to be condensed in a pretreatment process, which makes the measuring equipment simple in construction. Moreover, the reagent which can be treated with simple manner for the high-sensitive measurement is used instead of a high sensitive reagent which is required to be treated with care under a strict environmental condition.

### BRIEF DESCRIPTION OF THE DRAWINGS

FIG. 1(a) is a block diagram partly showing the measuring equipment according to one embodiment of the present invention, and FIG. 1(b) is an enlarged view showing the reaction part.

FIG. 2 is a schematic view showing the device according to one embodiment of the present invention.

FIG. 3 is a schematic view showing the manufacturing process of the device shown in FIG. 2.

FIG. 4 is a schematic view showing the concavities and convexities formed on the device shown in FIG. 3.

FIG. 5 is a schematic view showing the measuring system for measuring the number of concavities and convexities shown in FIG. 4.

FIG. 6 is a graph schematically showing the number of S-shaped signals indicative of the number of concavities and convexities with respect to the dilution ratio of the particles.

FIG. 7 is a schematic view showing the manufacturing process of the device having the antibody fixed thereon for conducting immunoassay.

FIG. 8 is a schematic view showing the measuring system for measuring the number of concavities and convexities, the concavities and convexities being formed as the result of the immunoassay shown in FIG. 7.

FIG. 9 is a graph schematically showing the relationship between the HSA concentration and the number of S-shaped signals measured by the measuring system shown in FIG. 8.

FIG. 10(a) is a schematic view showing the microscopic image of the device after cleansing the device by applying centrifugal force thereto with antigen-antibody reaction being employed, and FIG. 10(b) is a schematic view showing the microscopic image of the device after cleansing the device by applying centrifugal force thereto without antigen-antibody reaction being employed.

FIG. 11 is a schematic view showing the device operative to measure the amount of test substance without the latex reagent being introduced to the device by a user during the measuring process.

### DETAILED DESCRIPTION OF THE INVENTION

The embodiment of the measuring equipment according to the present invention will now be described in detail in accordance with accompanying drawings.

There are three significant aspects with regard to the measuring equipment according to the present invention.

1) The concavities and convexities are formed on the solid phase support having even and flat surface. 2) The concavities and convexities are formed as the result of the test reagent being reacted, competitively with the test substance in the specimen, with the specific binding substance fixed on the solid phase support. 3) The test reagent is constituted by a biomedical material attached with the shaped substance.

The aforementioned 1) will be described hereinafter. The light is projected to the concavities and convexities formed on the solid phase support. The intensity of the light transmitted through the solid phase support varies in response to the concavities and convexities resulting from the fact that the refractive index and reflectance of the solid phase support vary in response to the concavities and convexities. The variation of the light intensity can be regarded as a specific signal indicative of the concavities and convexities. Therefore, the number of concavities and convexities on the solid phase support can be calculated by measuring the specific signals with a light receiving unit. The concavities and convexities are formed on the solid phase support having even surface. In the meantime, the convexities may be formed on the solid phase support having surface with concavities, while the concavities may be formed on the solid phase support having surface with convexities.

The aforementioned 2) will be described hereinafter. The concavities and convexities are formed as the result of the test reagent and the test substance being reacted, with the specific binding substance fixed on the solid phase support. The specific binding substance is constituted by a biomedical material such as for example an antigen, an antibody, a nucleic acid, and a receptor.

In this embodiment of the present invention, the concavities and convexities on the solid phase support are formed when the shaped substance labeled with either the additional test substance or substitute substance having similar structural domain with the test substance is, competitively with the test substance in the specimen, reacted with the specific binding substance fixed on the solid phase support. In this case, the convexities are formed on the solid phase support having an even surface. The number of convexities to be formed is decreased with respect to the increase of the test substance in the specimen. Here, concavities may originally be formed on the solid phase support, and the surface of the solid phase support may become flat by introducing the test reagent. In this case, the number of concavities formed on the solid phase support is increased with respect to the increase of the test substance in the specimen. The concavities and convexities on the solid phase support may be formed by introducing on the solid phase support an additional specific binding substance together with the test substance to have the additional specific binding substance and the test substance being reacted with the specific binding substance on the solid phase support, in which the additional specific binding substance is specifically reactive with the test substance and is labeled with the shapes substance. In this case, convexities are formed on the solid phase support having an even surface, which is the same as when the shaped substance and the test substance are competitively introduced as aforementioned. However, the number of convexities is increased with respect to the increase of the test substance in the specimen. Here, the solid phase support may originally have a surface with concavities, and the surface may become flat by introducing the test reagent. In this case, the number of concavities is decreased with respect to the increase of the test substance in the specimen.

The aforementioned 3) will be described hereinafter. The test reagent is constituted by a biomedical material labeled with the shaped substance. The shaped substance has at least one of a spherical shape, elliptical shape and polyhedral shape. In this embodiment of the present invention, the shaped substance, as a concavity or a convexity to be formed on the solid phase support, has a diameter larger than a spot size of the light projected from the measuring system. It is preferable that the shaped substance have a spherical shape due to the fact that the specific signal indicative of the spherical shape is simple to be measured than other signals indicative of other shapes.

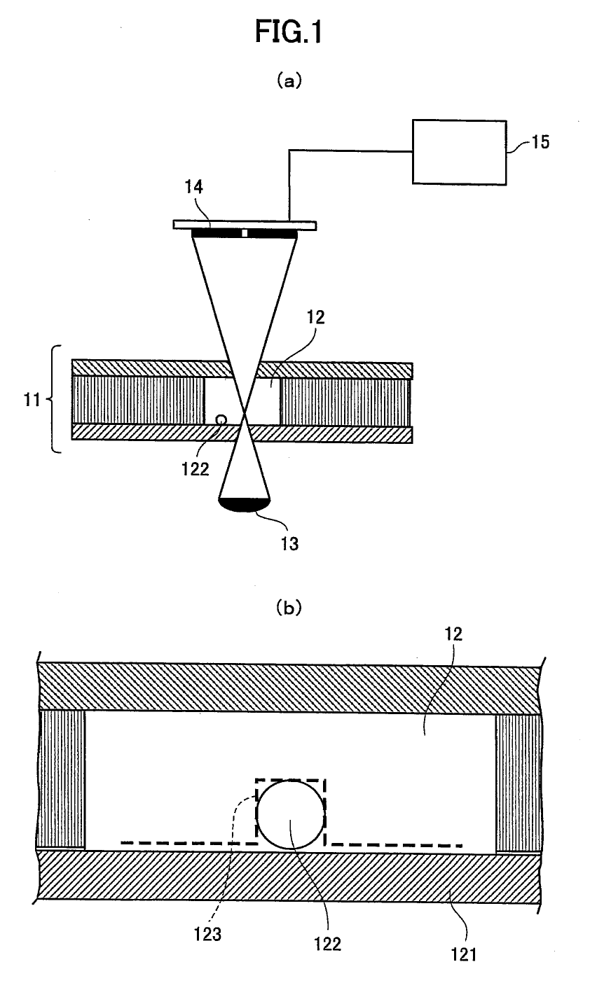

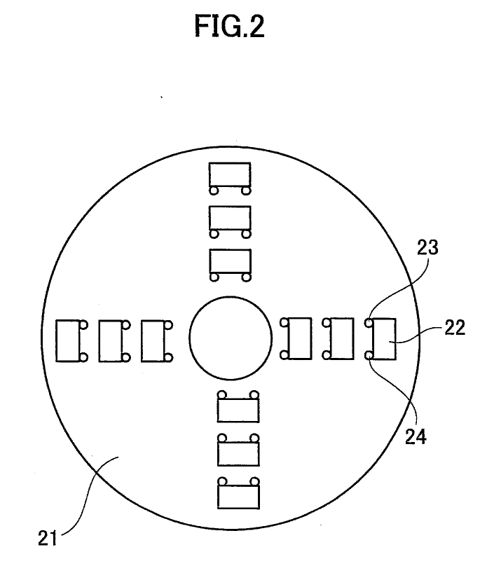

Referring now to FIGS. 1 and 2 of the drawings, there is shown one embodiment of a measuring equipment according to the present invention.

FIG. 1(a) shows a block diagram partly showing the measuring equipment according to one embodiment of the present invention, and FIG. 1(b) is an enlarged view showing the reaction part 12 under the condition that the light is not projected. The measuring equipment according to this embodiment comprises a light source 13, a light receiving unit 14 disposed in spaced relationship with the light source 13, and a device 11 disposed between the light source 13 and the light receiving unit 14. The device 11 has a reaction part 12 for accommodating therein a solid phase support 121, and a specific binding substance (not shown) specifically reactive with the test substance in the specimen. The specific binding substance is fixed on the solid phase support 121. The specific binding substance is adapted to have a plurality of concavities and convexities 123 formed on the solid phase support 121 by introducing the test substance and the test reagent in the reaction part 12, in which the test reagent is operative to react with any one of the test substance and the specific binding substance. The light source 13 is operative to produce a light to scan the device 11 in such a way that the light is transmitted through the solid phase support 121. The light has signals indicative of the concavities and convexities 123 on the solid phase support 121 after transmitting through the solid phase support 121. The light receiving unit 14 is operative to detect the signals of the light transmitted through the solid phase support 121.

The measuring equipment further comprises a driving unit for driving the device 11, and a display unit for displaying a result of the measurement, both of which are not shown in FIG. 1.

It is preferable that the light source be constituted by a laser light source, LED or the like which is operable to focus the light, instead of being constituted by a xenon lamp or a tungsten lamp generally used for a spectrophotometer. This results from the fact that the change in the shape of the surface within a microscopic area can be measured with the focused light, i.e. the intensity of the focused light varies as a signal with respect to each of the concavities and convexities 123 having a similar size to molecular. Here, it is important that the light is focused on the solid phase support 121 of the device 11. Therefore, the light source 13 should be adjusted to have the light focused at the desired position before the measurement of the signals indicative of the concavities and convexities. The measuring equipment according to this embodiment further comprises a controlling unit 15 for processing the signals received by the light receiving unit 14.

The object to be detected will now be described hereinafter. In this embodiment, the object to be detected is the shaped substance 122 forming concavities and convexities 123 on the solid phase support 121 by the shaped substance 122 being fixed with the specific binding substance (not shown) on the solid phase support 121. The specific binding substance is specifically reactive with the test substance in a specimen.

The shaped substance is capable of changing the physical quantity of the light focused thereon. The light receiving unit 14 accommodated in the measuring equipment is adapted to measure the variation of the physical quantity, especially the variation of the intensity, of the light caused by the shaped substance. Under the condition that the concavities and convexities 123 are not formed on the solid phase support 121, the light measured by the light receiving unit 14 has the intensity substantially equal to the intensity of the generated light by the light source 13. Under the condition that the concavities and convexities 123 are formed on the solid phase support 121, the variation of the light intensity is measured by the light receiving unit 14, the variation of the light intensity being caused by the change of refractive index, reflectance, and transmittance of the light path in response to the characteristics of the shaped substance. The shaped substance may be formed by a material having any one of permeability to light and impermeability to light. In this embodiment, it is preferable that the shaped substance be formed by a material with permeability to light under the condition that the light receiving unit 14 is positioned at the opposite side of the light source 13 with respect to the solid phase support 121. This comes from the fact that the light receiving unit 14 can receive the sufficient amount of light transmitted through the shaped substance, while the light projected to the shaped substance is easily affected by the refractive index of the shaped substance. Therefore, the signals of the light tend to indicate the concavities and convexities more precisely than the signals caused by the shaped substances having impermeability to light.

It is preferable that the light receiving unit 14 be constituted by two divided light receiving portions. The two divided light receiving portions are adapted to produce a simple S-shaped signal indicative of the shaped substance under the condition that the shaped substance has spherical shape. The S-shaped signal is produced by taking the differential of two signals respectively obtained from the two divided light receiving portions. The method to measure the S-shaped signal will be described in the examples.

The measuring equipment according to the present invention is, therefore, operative to measure the amount of test substance in the specimen with the steps that the light is projected from the light source 13 to the concavities and convexities by scanning the device 11, the variation of the light intensity is detected by the light receiving unit 14 resulting in the signals specific to the shaped substance being generated, and the number of signals is counted.

Here, fixing the light source 13 while moving the solid phase support 121 with the back-and-forth motion, moving the light source 13 and the solid phase support 121 reciprocally, and fixing the solid phase support 121 while moving the light source 13 with the back-and-forth motion, are among the methods to project the light from the light source 13 to the concavities and convexities 123. In this embodiment according to the present invention, it is preferable that the device 11 be constituted by a rotary table so that the light is projected to the rotating device. This comes from the reason that the mechanism to scan the rotating device in a radius direction is simpler than the mechanism to scan the device 11 with either the light source 13 or the device 11 being moved in two directions. For example, a mechanism similar to that of scanning a compact disc (CD) is preferable for scanning the device 11.

Under the condition that the scanning is performed with the rotary table as described in this embodiment, the concavities and convexities can be formed on the solid phase support with only one process. In this case, the rotation velocity of the rotary table is controlled to adjust the magnitude of the centrifugal force in such a way that the test reagent not contributing to form the concavities and convexities is urged to be removed, and that the test reagent bound with the specific binding substance without specific binding is urged to be washed out from the rotary table. Here, the rotation velocity of the rotary table is set on the basis of the magnitude of the centrifugal force to be applied to the shaped substance, and specific binding constant of the specific binding substance fixed on the solid phase support 121. The magnitude of the centrifugal force is calculated by the velocity of the position where the concavities and convexities are formed, and by the distance between the position and the center of the rotary table along the radius direction.

The rotation velocity of the rotary table may be set based additionally on the number of biomedical materials labeled by the shaped substance to form a test reagent. The rotation velocity may be set based additionally on the weight and the size of the shaped substance. The important thing to be considered for setting the rotation velocity is that the rotation velocity is decided so that the test reagent not contributing to form the concavities and convexities is urged to be removed, and a material attached to the specific binding substance with nonspecific binding is urged to be washed out. This setting process should be performed with deep consideration so that precise measurement can be conducted with the measuring device and the measuring system by reducing noise level caused by the specific binding substance with nonspecific binding.

The device 11 may further have a chamber, as a reagent holder, to have the test reagent received therein in a dry condition. The chamber is formed in a different position from the position where the concavities and convexities 123 are formed. In this case, the reaction part and the chamber are communicated through a passage therebetween.

The measuring equipment as described above makes it possible for a user to measure the amount of test substance with only one operation of introducing the specimen in the device 11. In this case, the specimen introduced in the device 11 is urged by the centrifugal force generated by the rotation of the device 11 to the chamber where the test reagent is held in a dry condition. The specimen is then mixed with the test reagent in the chamber. The specimen is again urged to the reaction part 12 by the centrifugal force generated by the rotation of the device 11. The specimen is then given sufficient time to be placed so that the concavities and convexities are formed on the reaction part 12. The device 11 is again rotated so that the test reagent not reacting with the specific binding substance is urged to be removed by the centrifugal force. The concavities and convexities, the number of which is response to the amount of test substance, are obtained. The result of the measurement is, therefore, simply obtained by controlling the rotation velocity and time of rotation of the device 11. While there has been described about the fact that the fluid containing the specimen is urged to be moved by the centrifugal force generated by the rotation of the device 11, the fluid may be urged to be moved by capillary force or electrophoretic force.

In this embodiment according to the present invention, the test reagent held in a dry condition in the chamber of the device 11 is made of a shaped substance having labeled thereto at least one of an additional test substance and a substitute substance having similar structural domain with the test substance, the shaped substance being adapted to form each of the concavities and convexities 123 on the solid phase support. The test reagent may be made of a shaped substance having labeled thereto an additional specific binding substance reactive with the test substance, the additional shaped substance being adapted to form each of the concavities and convexities 123 on the solid phase support.

The test reagent and the test substance are reacted with the specific binding substance fixed on the solid phase support in such a way that the test reagent and the test substance are competitively reacted with the specific binding substance, or in such a way that the test reagent is fixed with the specific binding substance through the test substance so that the test substance is sandwiched between the test reagent and the specific binding substance. Either of these reaction processes is the method of forming the concavities and convexities 123 on the solid phase support.

Different types of test reagents are respectively prepared to the above-mentioned two methods. In the former reaction process, the test reagent and the test substance being competitively reacted with the specific binding substance, the shaped substance labeled with any one of the additional test substance and the substitute substance having a structural domain similar to that of the test substance is used as the test reagent.

When the specific binding substance fixed on the solid phase support is made of an antigen, an antibody, or a nucleic acid, the material to be attached by the shaped substance is made of an antibody, antigen, or a nucleic acid, respectively. The base sequences of the former and latter nucleic acid are operative to be paired with each other. For the latter reaction process, the test substance being sandwiched between the test reagent and the specific binding substance, the test reagent is made of a shaped substance labeled with the additional specific binding substance, in which the shaped substance is adapted to form each of the concavities and convexities, and in which the additional specific binding substance is specifically reactive with the test substance.

In this case, the additional specific binding substance is made of an antibody capable of recognizing an antigen determinant under the condition that the antibody is chosen to form the specific binding substance fixed on the surface. The additional specific binding substance may be made of an antibody having similar characteristics with the antibody fixed on the solid phase support under the condition that the test substance is made of a multimeric complex. In either reaction process, the shaped substance is attached with the material having specificity peculiar to the biomedical material. While there has been described about the fact that the aforementioned attachment is caused by the reaction between the antibody and the antigen, or between the pair of nucleic-acid bases, the attachment may be caused by the reaction between a hormone and a receptor, or between a pair of sugar chains.

It is preferable that the process of specific binding between two of the test reagent, the test substance, and the specific binding substance result in forming bound complex. In the case that the specific reaction between the antibody and the antigen is replaced by the reaction between an enzyme and a substrate, it is impossible to form concavities and convexities on the solid phase support while resulting in the change of the substrate in characteristics. In this case, the specific binding between the enzyme and the substrate can be measured by detecting the change of optical or electrochemical characteristics. It would, meanwhile, be difficult to measure the specific binding between the enzyme and the substrate with the measuring equipment according to the present invention under the condition that the above-mentioned antibody is used. However, the measuring equipment according to the present invention can measure the reaction between the enzyme and the substrate under the condition that the structure of the substrate is changed by the reaction, and that the antibody is reactive only to the substrate whose structure of the substrate has been changed.

In this embodiment of the present invention, it is preferable that convexities be formed on the solid phase support 121 with even surface. The specific binding substance is evenly fixed more easily on the solid phase support 121 with even surface than on the solid phase support 121 with uneven surface, which leads to the fact that the device is precisely manufactured. Additionally, it is easy to detect the change of the surface shape in such a case that the surface shape is changed from evenness to convexity. Here, it is preferable that the solid phase support 121 be formed with a material capable of physical adsorption or chemical bonding with the biomedical material. The solid phase support 121 is, for example, preferable to be formed with a polystyrene, a styrene acrylate, a styrene butadiene, a divinylbenzene, or a polyvinyl benzene to be attached with the biomedical material with chemical bonding. The polystyrene is the most preferable among these materials due to the fact that the adsorption of the polystyrene with the biomedical material has been utilized in the form of a microtiter plate for an enzyme immunoassay.

The measuring equipment according to the present invention may be operative to measure the multiple items under the condition that various types of shaped substance are simultaneously introduced in the device. The introduction of various types of shaped materials different in size or in shape with one another results in the various shapes of concavities and convexities formed on the solid phase support. Therefore, multiple types of measurement are simultaneously conducted under the condition that the multiple types of shaped substance are respectively attached by the multiple types of specific binding substance, the multiple types of specific binding substance being specifically reactive with the multiple types of test substances, respectively.

The measuring equipment according to the present invention may be operative to output the result of the measurement as an image indicative of the detected signal. In this case, various types of concavities and convexities different in size can be visually recognized by the user through the image, which results in the plurality of test substances being identified.

In the present invention, the specimen is constituted by an organism derived object in the field of clinical assay such as for example a blood, a plasma, a urine, a saliva, and a sudor. In the present invention, the test substance is constituted by any one of a hormone, a protein or the like in the aforementioned specimen. In this case, the specific binding substance fixed on the solid phase support is preferred to be constituted by an antibody reactive with the aforementioned hormone or the protein, or by a receptor specifically binding with the aforementioned hormone. The material of the test reagent to be labeled with the shaped substance is preferred to be made of an antigen such as for example a hormone, a protein, and an epitope partly constituting any one of the hormone and the protein. The material of the test reagent to be labeled with the shaped substance may be preferred to be made of an antibody identical with the antibody to be fixed on the solid phase support, or an antibody operative to react with epitope different from the epitope to be reacted with the antibody to be fixed on the solid phase support.

The measuring equipment according to the present invention is available not only in the field of clinical assay, but also in the field of genetic testing and environmental inspection. In the field of genetic testing, the specimen to be measured by the measuring equipment may be identical to the specimen used in the aforementioned clinical assay, or may be constituted by a fluid extracted from a cell. In this case, the biomedical material fixed on the solid phase support and the biomedical material labeled by the shaped substance, each of which is required to form the concavities and convexities, are constituted by a DNA. In the field of environmental inspection, the specimen to be measured by the measuring equipment may generally be constituted by any one of tap water, stream water, and seawater. In this case, the test reagent in the field of clinical assay is mostly used for the biomedical material so that the measurement of the specimen is conducted on the basis of antigen-antibody reaction.

As described in the above, the measuring equipment according to the present invention makes it possible to easily remove the unreacted test reagent with the centrifugal force due to the fact that the shaped substance of the test reagent has a diameter longer than the spot size of the light. In other words, it has been impossible for the conventional measuring equipment to remove the unreacted test reagent with the centrifugal force resulting from the fact that the molecular size of the test reagent is too small to be urged by the centrifugal force. Therefore, it has been necessary for the conventional measuring equipment to remove the unreacted test reagent with water. The measuring equipment according to the present invention can remove the unreacted test reagent without using water, which leads to the fact that the measuring equipment is small in size with portability, and easy to be used by a user.

### EXAMPLES

Examples of the measuring equipment according to the present invention will be described in detail hereinafter based on measurement examples of Human Serum Albumin. The scope of the present invention is, however, no way limited by the following examples.

### Example 1

The fundamental structure of the device according to the present invention will be described in detail with reference to FIG. 2. FIG. 2 shows the device comprising a rotary table 21 having a detection chamber 22 formed therein. The test reagent labeled by the shaped substance and the specimen are held in the detection chamber 22. The rotary table 21 further has an air passageway and an injection passageway formed therein adjacent to the detection chamber 22.

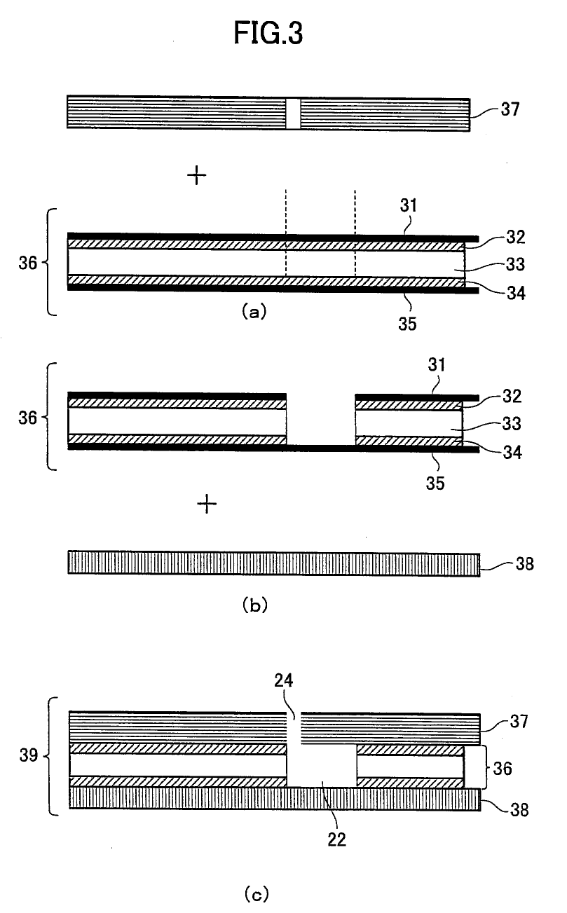

FIGS. 3(a) to 3(c) show the schematic views of the manufacturing process and the realization of the device. The device according to this example is formed with three layers.

As shown in FIG. 3(a), a two-sided adhesive sheet 36 (core layer having a thickness of 50 μm, adhesive layers on each side of the core layer having a thickness of 25 μm by FLEXCON) having a top release sheet 31 and a bottom release sheet 35 was prepared. The two-sided adhesive sheet 36 except for the bottom release sheet 35 was then incised with the cutting plotter (CE3000-40 by GRAPHTEC) to have a portion of the two-sided adhesive sheet removed therefrom to form a detection chamber 22.

As shown in FIG. 3(b), a base plate 38 formed with polycarbonate was prepared, and then coated with polystyrene (PS), the base plate 38 constituting the solid phase support. More specifically, the base plate 38 having a disk shape was coated with spin coating with a solution of 2-acetoxy-1-methoxypropane at a concentration rate of 1% (weight/volume) polystyrene (by SIGMA-ALDRICH). The base plate 38 coated with polystyrene was then placed in a vacuum for one night to ensure that the base plate 38 was sufficiently dried.

A top cover 37 having an injection passageway 24 and an air passageway 23 formed therein was then prepared. The top cover 37 and the base plate 38 were adhered with the two-sided adhesive sheet 36. Here, the air passageway 23 is not shown in FIG. 3(c).

### Example 2

The method of generating and measuring specific signals in response to the concavities and convexities with the device 39 shown in FIG. 3 will now be described hereinafter using latex particles (by Bangs Laboratories) each having a spherical shape and having a diameter any one of 2.06, 4.84, and 7.33 μm as the shaped substance.

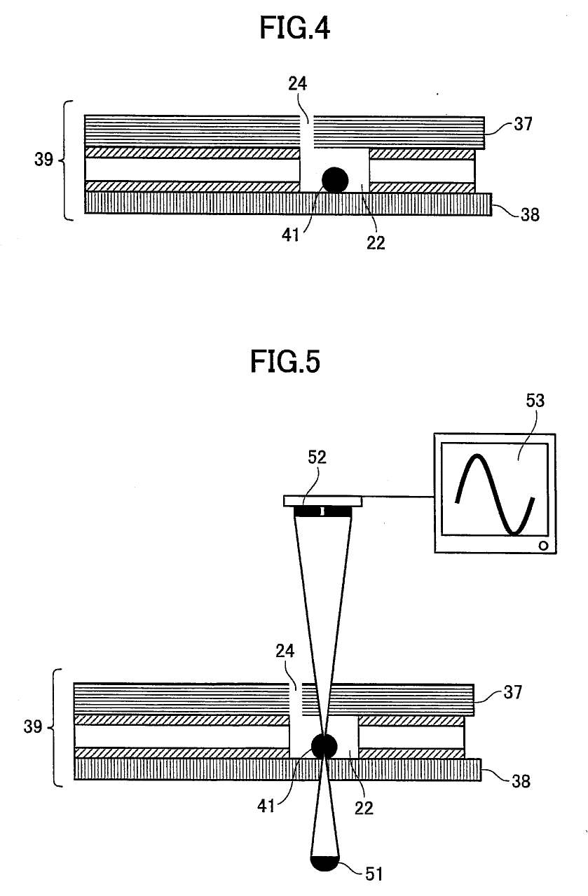

Firstly, the latex particles each having one of three types of size in diameter as above-mentioned were prepared. The latex particles in the form of a suspension were introduced in the device 39 through the injection passage 24, and were left intact for 6 minutes to ensure that the latex particles were attached on the solid phase support with nonspecific binding. Here, the latex particles can be attached on the base plate 38 due to the fact that both of the coating of the base plate 38 and the latex particles were formed with polystyrene. FIG. 4 shows the device 39 after the latex particle was attached on the base plate 38.

Next, the method of measuring the specific signals using the measuring equipment shown in FIG. 5 will now be described hereinafter. The device 39 was disposed between the light source 51 and the two divided light receiving portions 52. Signals generated by the two divided light receiving portions 52 were processed, and then displayed on the oscilloscope 53. Here, the oscilloscope 53 serves as a display means. The driving unit for rotating the device 39 is not shown in FIG. 5.

Next, a light was projected to the device 39 in such a way that the light was transmitted through the device 39 from the bottom to the top on this paper under the condition that the device 39 was rotated so that the device was scanned by the light source. The light transmitted through the device 39 was then detected by the two divided light receiving portions 52. S-shaped signals indicative of the concavities and convexities were then produced by the two divided light receiving portions 52 on the basis of the detected light. The number of S-shaped signals was counted with the oscilloscope 53.

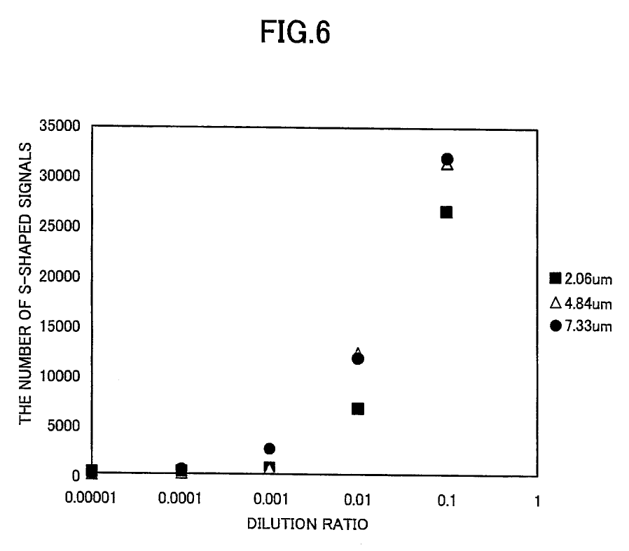

FIG. 6 is a graph showing that the number of detected S-shaped signals is varied in response to the number of latex particles contained in the diluted suspension. Here, three types of latex particles were prepared having different diameters with one another. The vertical axis represents the number of S-shaped signals measured by counting the signals displayed by the oscilloscope 53. The horizontal axis represents several degrees of dilution of suspensions prepared for each type of latex particles, where 10% solids of the suspensions were used. According to the measurement in this example, the number of signals displayed by the oscilloscope 53 was increased as the degree of dilution of suspensions was increased, which results in the fact that the number of concavities and convexities on the base plate 38 is dependent upon the number of latex particles.

### Example 3

The measuring method according to the present invention exemplified by the immunoassay using the antigen labeled with latex will now be described hereinafter. In this example, Human Serum Albumin (simply referred to as HSA) contained by Phosphate buffered solution (PBS) was used for the measurement using the competitive reaction.

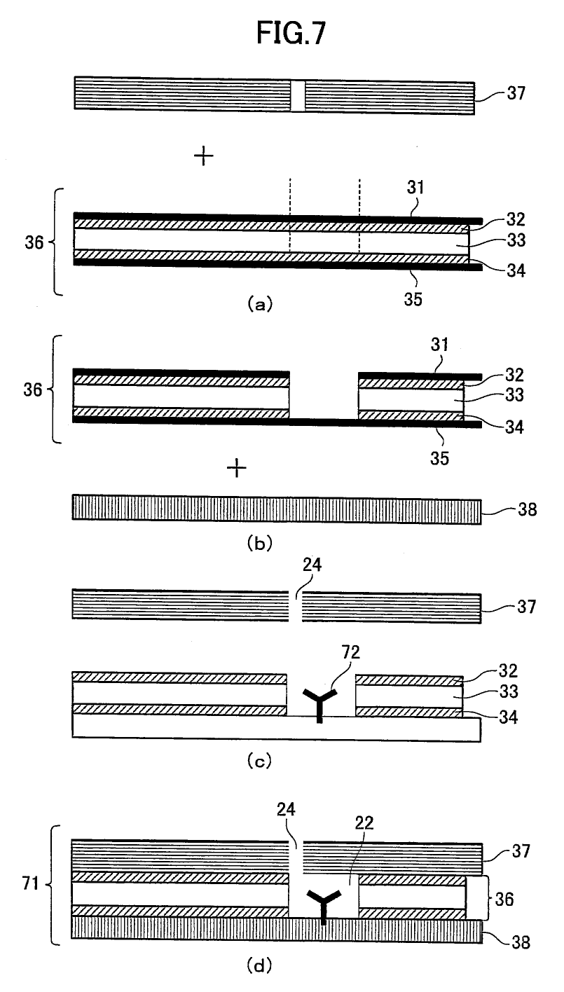

FIGS. 7(a) to 7(d) respectively show the schematic views of the manufacturing process of the device 71. As shown in FIGS. 7(a) and 7(b), the fundamental manufacturing process of the device 71 is similar to the manufacturing process of the device shown in the Example 1. In this example, the antibody 72 was fixed on the base plate 38 before the top cover 37 was adhered with the two-sided adhesive sheet 36 to ensure that the antigen-antibody reaction was conducted within the detection chamber. As shown in FIG. 7(c), 10 ml of Phosphate buffered solution containing 1.0 mg/ml of rabbit anti-Human Serum Albumin polyclonal antibody (hereinafter referred to as anti-HSA polyclonal antibody) was introduced in the chamber 22, and then left intact for 3 hours to ensure that anti-HSA polyclonal antibody was fixed on the base plate 38. The base plate 38 was then washed with ultrapure water, and blocking was performed with StabilGuard (by SurModics, Inc.) for 3 hours. The base plate 38 was again washed, and water left at the edge of the detection chamber was then removed with a vacuum pump.

The device 71 according to the present invention was then manufactured by adhering the top cover 37 to the base plate 38 through two-sided adhesive sheet 36 as shown in FIG. 7(d), with the antibody 72 being fixed on the base plate 38.

The producing method of the test reagent labeled with latex particles will now be described in detail hereinafter.

In this example, latex particles each having a diameter of 7.33 μm (by Bangs Laboratories) were used as the shaped substance.

Firstly, a process of washing the latex particles was conducted. The supernatant fluid was removed from the latex particles with centrifugal force. The latex particles were then suspended in a PBS to ensure that the latex particles were washed. This process of washing the latex particles was repeated 5 times. After being washed, the latex particles suspended in 400 μl of PBS was mixed with 100 μl of Phosphate buffered solution containing 3.0 mg/ml of Human Serum Albumin (HSA), and stirred by a ball mill for 3 hours. The HSA not binding with the latex particles was then removed with the centrifugal force. After blocking was performed with StabilGuard for 3 hours, washing process was performed to the latex with centrifugal force.

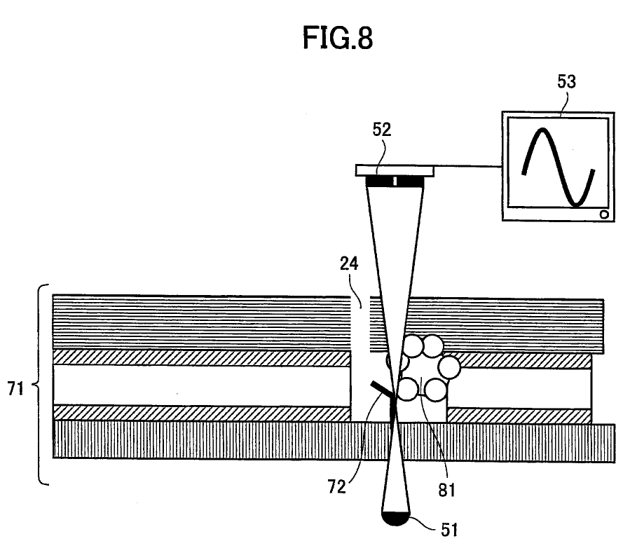

The measurement of the HSA was then conducted using the device and the test reagent labeled with latex manufactured in this example. 10 μl of the aforementioned test reagent labeled with latex was mixed with 90 μl of HSA having a concentration of any one of 0, 1, 10, 30, 50, and 120 mg/dl, and introduced in the device 71. The device 71 was then rotated for 5 minutes so that the centrifugal force with 35 G was applied to the test reagent. The measurement of the number of S-shaped signals using the HSA was then conducted with the constitution of the measuring system shown in FIG. 8.

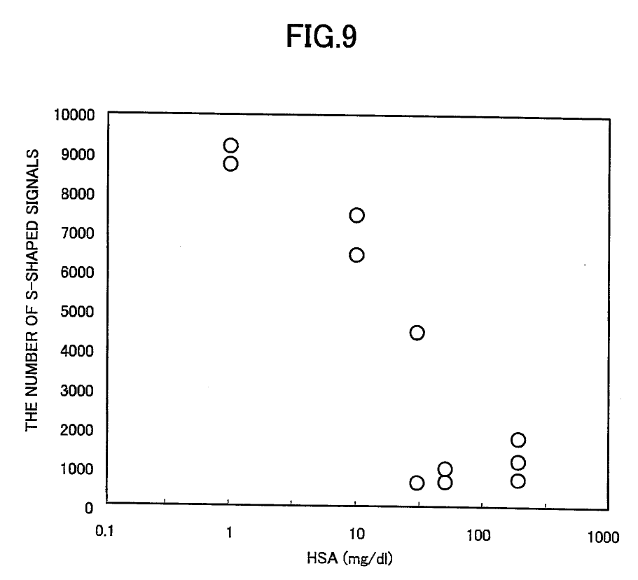

FIG. 9 is a graph schematically showing the relationship between the HSA concentration and the measured number of S-shaped signals. The number of S-shaped signals detected by the measuring equipment was decreased as the concentration of the HSA was increased, and was ranged from 500 to 10000. It was therefore verified that the test reagent labeled with latex was capable of being utilized in the measuring method according to the present invention due to the fact that the maximum number of the detected S-shaped signals is 20 times more than the minimum number of the detected S-shaped signals within the detectable range, the range being wide enough to distinguish the number of the S-shaped signals with respect to each concentration of the test substance in this example.

It is difficult for the conventional measuring equipment to have a detectable range wide enough to be measured due to the fact that the difference of maximum number and minimum number of the detected signals is smaller than 20 times when the light is used for scanning. This comes from the reason that the light path length of the conventional measuring equipment becomes short as the conventional measuring equipment becomes small in size. In addition, forward scattering makes the sensitivity of the detection deteriorated. The measuring equipment according to the present invention, meanwhile, can have a detectable range same as the range of general spectrometers independently of the length of the light path as aforementioned in this example.

Though it has not been described in detail in this example, the result of the experiment showed that the number of the detected signals had dependency on the concentration of the test substance under the condition that the measurement according to the present invention was conducted with the test reagent being fixed with the specific binding substance through the test substance so that the test substance was sandwiched between the test reagent and the specific binding substance.

### Example 4

The unreacted test reagent not contributing to the antigen-antibody reaction was removed within a short time by changing the rotation velocity of the device from the rotation velocity described in the example 3.

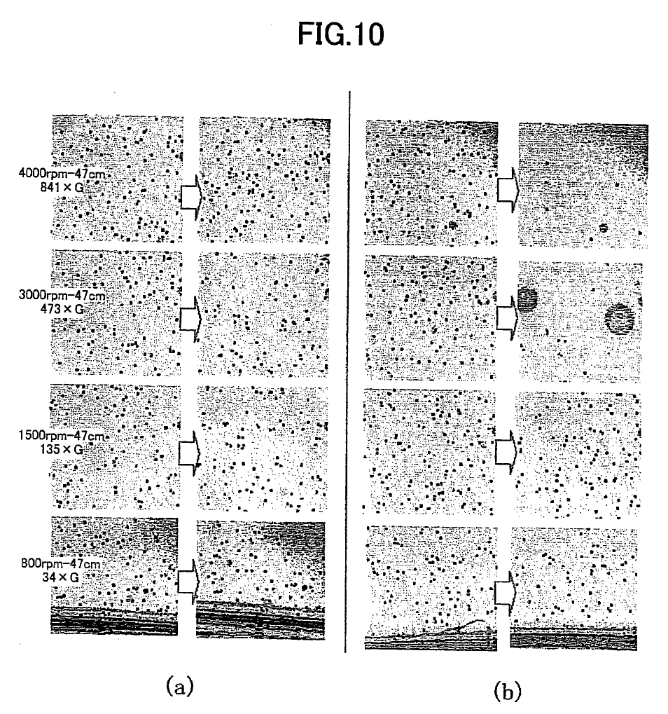

FIG. 10 is a schematic view showing the microscopic image of the device after the device being cleansed with the centrifugal force applied to the unreacted test reagent for 5 minutes, the centrifugal force being any one of 34 G; 135 G, 473 G; and 841 G. FIG. 10(a) shows the microscopic images of the device at a magnification of 200 times under the condition that reaction between Anti-Hemoglobin A1c antibody (by Exocell) and the glycated peptide-bound HSA labeled with latex was controlled to be positive (immune reaction was caused). FIG. 10(b) shows the microscopic images of the device at a magnification of 200 times under the condition that reaction between Anti-Hemoglobin A1c antibody (by Exocell) and the HSA labeled with latex was controlled to be negative (immune reaction was not caused). Here, the microscopic images on the left side of FIGS. 10(a) and 10(b) show the device before applying centrifugal force, and the microscopic images on the right side of FIG. 10(a) and 10(b) show the device after applying centrifugal force for 5 minutes.

The device in this Example is similar in construction to the device in Example 3. In this example, the Anti-Hemoglobin A1c antibody was utilized as the antibody to be fixed on the base plate 38.

As shown in FIG. 10, the unreacted test reagent can be removed under the condition that the intensity of the centrifugal force applied to the unreacted test reagent is more than 473 G. The intensity of the centrifugal force to cleanse the device is expected to vary with respect to the binding constant of the antibody to be fixed on the base plate, and the number of the test substance to be labeled with the latex particles (each having a diameter of 7.2 μm in this Example) to form the test reagent.

As aforementioned, the measuring equipment according to this embodiment can remove the unreacted test reagent, a cause for the noise signal, by controlling the rotation velocity of the device in such a way that the magnitude of the centrifugal force applied to the unreacted test reagent is adjusted, which results in high accuracy of the measurement. In addition, the measuring equipment according to this embodiment can be simple in construction due to the fact that the unreacted test reagent is easily removed with one step of controlling the rotation velocity and the rotation time of the device.

The method of producing the glycated peptide-bound HSA will be described hereinafter. 200 mg (2.98*10³ mol) of HSA was dissolved into the 10 ml of PBS, and was mixed with 1 ml of ethanol solution of Succinimidyl pyridyldithio propionate (by Wako, hereinafter referred to as SPDP, SPDP=46.6 mg, 0.149 mol, 50 times in weight) while keeping the solution stirring. After stirring at room temperature for 30 minutes, the resultant precipitate was filtered out with a 0.22 μm filter. The filtrate was subjected to gel filtration using a Sephadex G25M column (by Pharmacia), which resulted in obtaining 14 ml of HSA-SPDP. 13.8 mg of 1-deoxyfructose-Val-His-Leu-Thr-Cys (by Peptide Institute, hereinafter referred to as FVHLTC) was then added to be reacted overnight at 4° C. After the reaction, the number of binding between the FVHLTC and the HSA was determined by measuring the amount of by-product, pyridine-2-thione, in the solution. The amount of pyridine-2-thione was calculated based on the degree of optical absorbance at 343 nm. According to the above-mentioned measurement, glycated peptide-bound HSA was formed with HSA molecule bound with 15 FVHLTCs. The aforementioned example was conducted with reference to the typical example of reaction and references shown in DOJINDO Catalog (DOJINDO LABORATRIES 23rd Edition, P253˜254, 2002).

### Example 5

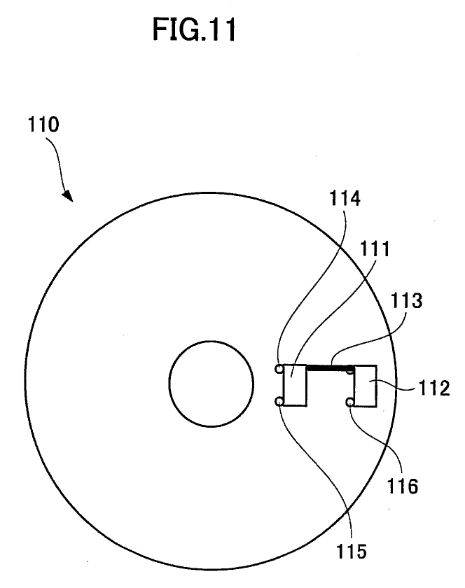

The device according to the aforementioned examples of the invention can be applied to the measuring equipment which is unnecessary to introduce by a user a test reagent during measurement with the device further having another chamber 111 formed therein as a reagent holder. The chamber 111 is adapted to receive the test reagent described in Example 3 in a dry condition. FIG. 11 shows the device 110 with the chamber 111. The device 110 further has a plurality of air passageway 114, 116 formed therein in the vicinity of the chamber 111, 112, respectively. The device 110 further has an injection passageway 115 formed therein in the vicinity of the chamber 111.

The fundamental manufacturing process of the device 110 is similar to the manufacturing process of the device shown in the Example 1. The device 110 further has a conduit 113 to connect the chamber (reagent holder) 111 with the chamber (reaction part) 112 and having a passageway formed therein to allow the test reagent in the chamber 111 (reagent holder) to pass to the chamber 112 (reaction part).

The measuring method of this example will be described hereinafter. Firstly, the specimen liquid was introduced to be suspended and mixed with the test reagent labeled with latex. The reagent was urged to be moved by the centrifugal force from the chamber 111 to the chamber 112 to be detected. The unreacted test reagent was then removed by controlling the rotation velocity and the rotation time of the device. The detection of S-shaped signals was then conducted with the same method described in Example 2. The result of the measurement obtained according to the Example 5 was similar to the result obtained in Example 3.

It will be understood from the forgoing fact that the result of the measurement is obtained with ease and high accuracy by introducing the specimen and controlling the rotation velocity and the rotation time of the device.

### INDUSTRIAL APPLICABILITY OF THE PRESENT INVENTION

In accordance with the present invention, there is provided a measuring equipment and measuring method which can measure the amount of protein in a blood with high accuracy, the measuring equipment and measuring method being available for such as for example the field of clinical assay.

What is claimed is:

1. A measuring equipment, comprising:
a light source;
a light receiving unit disposed in spaced relationship with said light source;
a device disposed between said light source and said light receiving unit;
said device having a reaction part for accommodating therein a solid phase support, a test substance in a specimen, and a test reagent operative to react with any one of said solid phase support and said test substance,
said solid phase support having a surface having a specific binding substance fixed thereon, said specific binding substance being specifically reactive with said test substance, in which,
said specific binding substance is adapted to have a plurality of concavities and convexities formed on said solid phase support with said test reagent and said test substance introduced into said reaction part and reacted with each other,
said light source is operative to produce a light to transmit through said solid phase support and scan said device, said light transmitted through said solid phase support having a signal indicative of said concavities and convexities on said solid phase support,
said signal of said light indicative of said concavities and convexities transmitted through said solid phase support being detected by said light receiving unit.

2. A measuring equipment as set forth in claim 1, in which
each of said concavities and convexities on said solid phase support is formed with a shaped substance having a permeability to light.

3. A measuring equipment as set forth in claim 1, in which
said light receiving unit is constituted by two divided light receiving portions, and
said light receiving unit is operative to measure an intensity of said light transmitted through said solid phase support, said intensity being varied in response to the shape of each of said concavities and convexities.

4. A measuring equipment as set forth in claim 1, in which
said concavities and convexities are scanned with said light source by shifting the relative position of said light source with respect to said device with a predetermined space interval.

5. A measuring equipment as set forth in claim 1, in which
said device is constituted by a rotary table operative to rotate around the central axis of said rotary table, and
said concavities and convexities are scanned under the condition that said rotary table is rotated.

6. A measuring equipment as set forth in claim 5, in which
the rotation velocity and the rotation time of said device are determined in such a way that said device has a nonspecific binding substance removed from said device after said test reagent is introduced in said device.

7. A measuring equipment as set forth in claim 1, in which
said device further includes a reagent holder to have said reagent held therein in a dry condition, and a conduit to connect said reagent holder with said reaction part and having a passageway formed therein to allow said reagent in said reagent holder to pass to said reaction part.

8. A measuring equipment as set forth in claim 7, in which
said test reagent is made of at least one shaped substance labeled with any one of an additional test substance and a substitute substance to ensure that said test substance is easily inspected by intercepting the light from said light source to said light receiving unit, said substitute substance having a structural domain similar to the structural domain of said additional test substance.

9. A measuring equipment as set forth in claim 7, in which
said test reagent is made of a shaped substance labeled with an additional specific binding substance reactive with said test substance to ensure that said test substance is easily inspected by intercepting the light from said light source to said light receiving unit.

10. A measuring equipment as set forth in claim 8, in which
said test reagent labeled with any one of said additional test substance and said substitute substance is adapted to form each of said concavities and convexities on said solid phase support, and
said additional test substance and said substitute substance are reacted with said specific binding substance competitively with said test substance in said specimen.

11. A measuring equipment as set forth in claim 9, in which
said additional specific binding substance is specifically reactive with said test substance, and fixed with said specific binding substance through said test substance in said specimen to form each of said concavities and convexities on said solid phase support.

12. A measuring equipment as set forth in claim 1, further comprising
display means for displaying an image indicative of said signal, said signal specific to a shape of each of said concavities and convexities on said solid phase support.

13. A measuring method of measuring an amount of test substances in a specimen, comprising:
a fixing step of fixing a specific binding substance on a solid phase support, said specific binding substance being specifically attached to said test substances,
a forming step of forming concavities and convexities on said solid phase support by introducing a test reagent and said specimen on said solid phase support, said test reagent being reactive with any one of said test substance and said specific binding substance,
a detecting step of detecting a light projected on said solid phase support, said light having a specific signal indicative of said concavities and convexities on said solid phase support, said light being detected in such a way that said amount of test substances is measured on the basis of said specific signal.
